(19) United States
(12) Patent Application Publication
(10) Pub. No.: US 2003/0097591 A1
(43) Pub. Date: May 22, 2003

(54) System and method for protecting computer users from web sites hosting computer viruses

(76) Inventors: Khai Pham, Beaverton, OR (US); Yoshihiro Yasuda, Beaverton, OR (US); Dmitry Gryaznov, Portland, OR (US); Jimmy Kuo, Torrance, CA (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/988,606

(22) Filed: Nov. 20, 2001

(51) Int. Cl. G06F 12/14

(52) U.S. Cl. 713/201

(57) ABSTRACT

A method, system, and computer program product for protecting computer users from Web sites hosting computer viruses and for protecting Web hosting systems from hosting Web pages that contains links to computer viruses. a method for protecting users from Web sites hosting computer viruses comprises the steps of: receiving information identifying a Web page selected for access by a user, determining whether the Web page is hosted by a Web site that is included in a database of Web sites related to computer viruses, and allowing access to the Web page based on whether the Web page includes a link to a Web site that is included in the database.

### FIELD OF THE INVENTION

The present invention relates to protecting computer users from Web sites hosting computer viruses and for protecting Web hosting systems from hosting Web pages that contains links to computer viruses.

### BACKGROUND OF THE INVENTION

As the popularity of the Internet has grown, the proliferation of computer viruses has become more common. A computer virus is a program or piece of code that is loaded onto a computer without the knowledge or consent of the computer operator. Most viruses replicate themselves and load themselves onto other connected computers. One way in which viruses proliferate is to load themselves into a computer along with a Web page that a user of the computer has selected. Once the virus has been loaded onto the computer, it is activated and may proliferate further and/or damage the computer or other computers.

In order to prevent this, it is desirable to prevent computer users from loading Web pages that are infected with computer viruses. An effective way to do this is to prevent Web hosting services from linking to infected Web pages. However, finding Web sites that contain infected Web pages and Web pages that link to infected Web pages is a difficult problem. Web pages containing links to infected Web pages on virus Web sites are changed constantly by malicious individuals who try to maximize the spread of the viruses, while hiding themselves from the law. Furthermore, it can be difficult to determine which Web sites contain viruses. A need arises for a technique by which Web sites that contain viruses can be identified, so that Web hosting systems can be prevented from linking to such Web sites.

An additional problem arises when users create Web pages that are to be hosted by a Web hosting system. Some users may create Web pages that, knowingly or unknowingly, link to Web pages that contain links to infected Web pages on virus Web sites. A need arises for a technique by which Web pages that contain viruses can be identified, so that Web hosting systems can be prevented from hosting such Web pages.

### SUMMARY OF THE INVENTION

The present invention is a method, system, and computer program product for protecting computer users from Web sites hosting computer viruses and for protecting Web hosting systems from hosting Web pages that contains links to computer viruses.

In one embodiment of the present invention, a method for protecting users from Web sites hosting computer viruses comprises the steps of: receiving information identifying a Web page selected for access by a user, determining whether the Web page is hosted by a Web site that is included in a database of Web sites related to computer viruses, and allowing access to the Web page based on whether the Web page includes a link to a Web site that is included in the database.

In one aspect of the present invention, the method further comprises the step of preventing access to the Web page before determining whether the Web page is included in the database. The allowing step may comprise the steps of allowing access to the Web page, if the Web page is determined not to be included in the database and continuing to prevent access to the Web page, if the Web page is determined to be included in the database.

In one aspect of the present invention, the method further comprises the step of allowing access to the Web page before determining whether the Web page is included in the database. The allowing step may comprise the steps of continuing to allow access to the Web page, if the Web page is determined not to be included in the database and preventing access to the Web page, if the Web page is determined to be included in the database.

In one aspect of the present invention, the method further comprises the step of generating the database of Web sites related to computer viruses. The generating step may comprise the steps of extracting, from a first Web page, a link to a second Web page, fetching the second Web page using the link, scanning the second Web page for computer viruses and storing information relating to a Web site that is hosting the second Web page in the database. The stored information may include information identifying the Web site that is hosting the second Web page and information identifying any computer viruses that were found in the second Web page. The method may further comprise the steps of extracting, from each Web page fetched, links to other Web pages, fetching the other Web pages using the links, scanning the other Web pages for computer viruses, and storing information relating to Web sites that are hosting the other Web pages in the database. The stored information may include information identifying the Web sites that are hosting the other Web pages and information identifying any computer viruses that were found in the other Web pages.

In one aspect of the present invention, the generating step comprises the steps of extracting, from a first Web page, a link to a second Web page, fetching the second Web page using the link, scanning the second Web page for terminology relating to computer viruses, reviewing content of the second Web page to determine whether a Web site hosting the second Web page is virus hosting, if the second Web page includes terminology relating to computer viruses, and storing information relating to the Web site that is hosting the second Web page in the database. The stored information may include information identifying the second Web page and information identifying any computer viruses that were found in the second Web page. The method may further comprise the steps of extracting, from each Web page fetched, links to other Web pages, fetching the other Web pages using the links, scanning the other Web pages for terminology relating to computer viruses, reviewing content of those other Web pages that include terminology relating to computer viruses to determine whether Web sites hosting the other Web page are virus hosting, and storing information relating to the Web sites that are hosting the other Web pages in the database. The stored information may include information identifying the Web sites that are hosting the other Web pages and information identifying any computer viruses that were found in the other Web pages.

In one embodiment of the present invention, a method for protecting a Web hosting system from hosting a Web page that contains a link to a computer virus comprises the steps of receiving information identifying a first Web page to be hosted by the Web hosting system, determining whether the first Web page includes a link to a Web site that is included in a database of Web sites related to computer viruses, and allowing hosting of the first Web page based on whether the Web page includes a link to a Web site that is included in the database. The determining step may comprise the steps of extracting, from the first Web page, links to other Web pages and determining whether the other Web pages are hosted by Web sites that are included in the database. The allowing step may comprise the steps of refusing to host the first Web page, if the first Web page includes a link to a Web page that is hosted by a Web site that is included in the database and hosting the first Web page, if the first Web page includes no links to a any Web pages that are hosted by a Web site that is included in the database.

In one aspect of the present invention, the method further comprises the step of generating the database of Web sites related to computer viruses. The generating step may comprise the steps of extracting, from a first Web page, a link to a second Web page, fetching the second Web page using the link, scanning the second Web page for computer viruses, and storing information relating to a Web site that is hosting the second Web page in the database. The stored information may include information identifying the Web site that is hosting the second Web page and information identifying any computer viruses that were found in the second Web page. The method may further comprise the steps of extracting, from each Web page fetched, links to other Web pages, fetching the other Web pages using the links, scanning the other Web pages for computer viruses, and storing information relating to Web sites that are hosting the other Web pages in the database. The stored information may include information identifying the Web sites that are hosting the other Web pages and information identifying any computer viruses that were found in the other Web pages.

In one aspect of the present invention, the generating step comprises the steps of extracting, from a first Web page, a link to a second Web page, fetching the second Web page using the link, scanning the second Web page for terminology relating to computer viruses, reviewing content of the second Web page to determine whether a Web site hosting the second Web page is virus hosting, if the second Web page includes terminology relating to computer viruses, and storing information relating to the Web site that is hosting the second Web page in the database. The stored information may include information identifying the second Web page and information identifying any computer viruses that were found in the second Web page. The method may further comprise the steps of extracting, from each Web page fetched, links to other Web pages, fetching the other Web pages using the links, scanning the other Web pages for terminology relating to computer viruses, reviewing content of those other Web pages that include terminology relating to computer viruses to determine whether Web sites hosting the other Web page are virus hosting, and storing information relating to the Web sites that are hosting the other Web pages in the database. The stored information may include information identifying the Web sites that are hosting the other Web pages and information identifying any computer viruses that were found in the other Web pages.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a typical system incorporating the present invention.

FIG. 2 is an exemplary block diagram of an anti-virus system, which may implement the present invention.

FIG. 3 is an exemplary flow diagram of a process for locating and cataloging virus Web sites.

FIG. 4 is an exemplary flow diagram of a security process for protecting users from virus Web sites.

FIG. 5 is an exemplary format of a record in a virus site database shown in FIG. 1.

FIG. 6 is an exemplary flow diagram of a process for protecting a Web hosting system from hosting a Web page that contains a link to a computer virus.

### DETAILED DESCRIPTION OF THE INVENTION

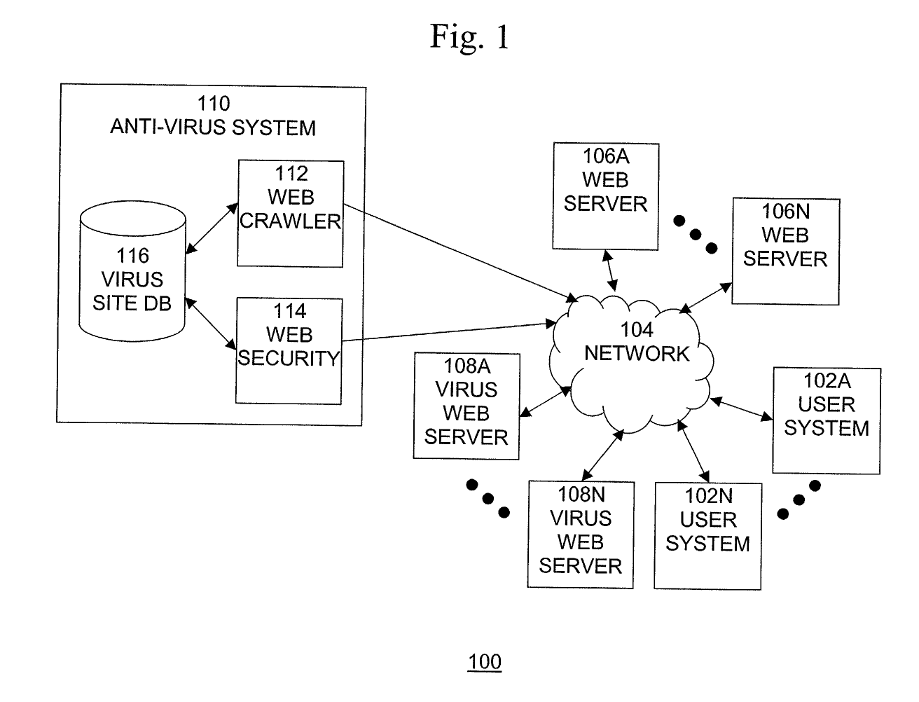

An exemplary block diagram of a typical system 100 incorporating the present invention is shown in FIG. 1. System 100 includes a plurality of user systems 102A-N, such as personal computer systems operated by users, which are communicatively connected to a data communications network 104, such as a public data communications network, for example, the Internet, or a private data communications network, for example, a private intranet. User systems 102A-N generate and transmit requests for information over network 104 to Web servers, such as Web servers 106A-N. Web servers are computers systems that are communicatively connected to a data communications network, such as network 104, which store and retrieve information and/or perform processing in response to requests received from other systems. Typically, the requests for information or processing are generated by a Web browser software running on user systems 102A-N in response to input from users. The requests for information or processing that are received, for example, by Web server 106A, are processed and responses, typically including the requested information or results of the processing, are transmitted from Web server 106A to the requesting user systems.

A problem that arises is that some Web servers contain computer viruses, which are disseminated to user systems operated by unsuspecting users, when the user systems request information from the Web servers that contain computer viruses. For example, virus Web servers 108A-N, which are communicatively connected to a data communications network, such as network 104, contain computer viruses, and typically transmit such viruses to user systems, such as user systems 102A-N, along with desired information requested by the user systems.

Anti-virus system 110, which is communicatively connected to a data communications network, such as network 104, includes Web crawler system 112, Web security system 114, and virus site database system 116. Web crawler system 112 includes a Web crawler or spider software program. A Web crawler (or spider) is a program that automatically fetches Web pages, which are then typically cataloged in a database. Such a program is termed a Web crawler because it crawls over the Web. A Web crawler starts at a given Web page, then follows all links to other pages that are contained in that page. The Web crawler then follows all links contained in the linked pages, and so on. Because most Web pages contain links to other pages, a Web crawler can start almost anywhere. As soon as it sees a link to another page, it goes off and fetches it. Web crawlers are typically used to provide data for search engines, which is then cataloged in a database to provide searching functionality. A typical large search engine may have many Web crawlers working in parallel.

Web crawler system 112 performs this Web crawling function, but in addition, examines the content of each page that is fetched in order to determine whether the page contains a computer virus, or information relating to a computer virus. Information relating to pages that have been examined, in addition to information relating to pages that are found to contain a computer virus, or information relating to a computer virus, is stored in virus site database system 116.

Web security system 114 can then use the information in virus site database 116 to provide a screening service, in which requests for particular Web pages are screened against the information in virus site database 116 to detect and, if desired, prevent fulfillment of requests for Web pages that contain a computer virus, or information relating to a computer virus.

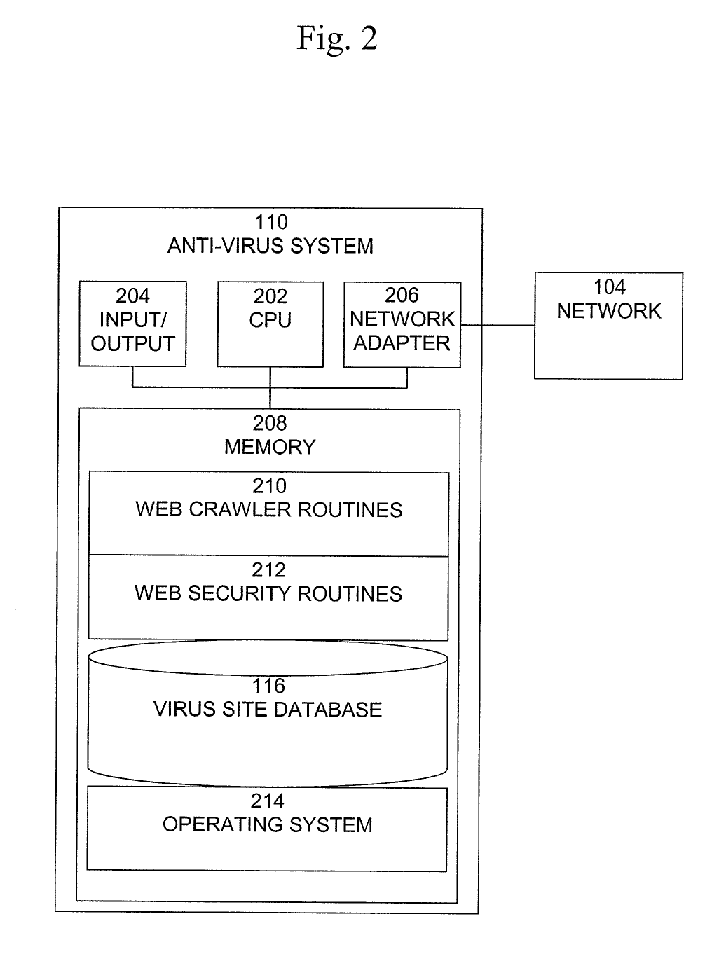

An exemplary block diagram of an anti-virus system 110, which may implement the present invention, is shown in FIG. 2. Anti-virus system 110 is typically a programmed general-purpose computer system, such as a personal computer, workstation, server system, and minicomputer or mainframe computer. Anti-virus system 110 includes processor (CPU) 202, input/output circuitry 204, network adapter 206, and memory 208. CPU 202 executes program instructions in order to carry out the functions of the present invention. Typically, CPU 202 is a microprocessor, such as an INTEL PENTIUM® processor, but may also be a minicomputer or mainframe computer processor. Although in the example shown in FIG. 2, computer system 200 is a single processor computer system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which anti-virus system 110 is implemented on a plurality of networked computer systems, which may be single-processor computer systems, multi-processor computer systems, or a mix thereof.

Input/output circuitry 204 provides the capability to input data to, or output data from, anti-virus system 110. For example, input/output circuitry may include input devices, such as keyboards, mice, touchpads, trackballs, scanners, etc., output devices, such as video adapters, monitors, printers, etc., and input/output devices, such as, modems, etc. Network adapter 206 interfaces anti-virus system 110 with network 104. Network 104 may be any standard local area network (LAN) or wide area network (WAN), such as Ethernet, Token Ring, the Internet, or a private or proprietary LAN/WAN.

Memory 208 stores program instructions that are executed by, and data that are used and processed by, CPU 202 to perform the functions of the present invention. Memory 208 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 208 includes Web crawler routines 210, Web security routines 212, virus site database 116, and operating system 214. Web crawler routines 210 implement the functionality of Web crawler system 112, which crawls the Web, fetches Web pages, examines the content of each page that is fetched in order to determine whether the page contains a computer virus, or information relating to a computer virus, and stores the information relating to pages that have been examined, in addition to information relating to pages that are found to contain a computer virus, or information relating to a computer virus, in virus site database system 116. Virus site database 116 contains the information relating to pages that have been examined and the information relating to pages that are found to contain a computer virus, or information relating to a computer virus, stored in a database format. This provides the capability to search the stored information for information relating to particular Web pages. Web security routines 212 implement the functionality of Web security system 114, which accepts requests for particular Web pages, searches the information in virus site database 116 for information relating to those Web pages, and screens the requested Web pages against the information in virus site database 116 to detect and, if desired, prevent fulfillment of requests for Web pages that contain a computer virus, or information relating to a computer virus. Operating system 214 provides overall system functionality.

Although, in FIG. 2, Web crawler routines 210, Web security routines 212, and virus site database 116 are all shown implemented on a single computer system, this is only an example. The present invention contemplates any arrangement of these functions among any number of communicatively connected computer systems. For example, each of Web crawler routines 210, Web security routines 212, and virus site database 116 may be implemented on one or more communicatively connected computer systems, or these functions may be distributed as desired. The present invention contemplates any and all such arrangements.

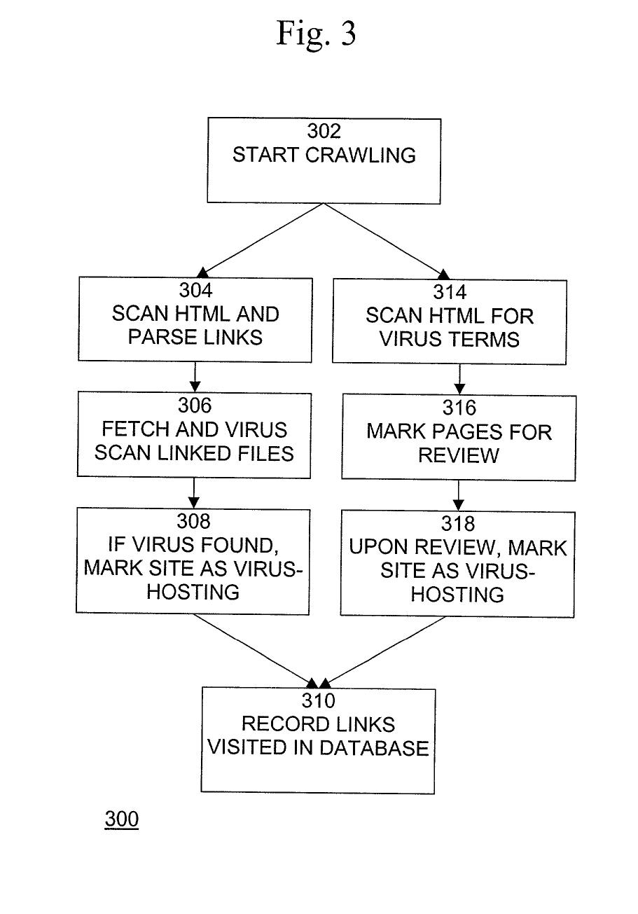

An exemplary flow diagram of a process 300 for locating and cataloging virus Web sites is shown in FIG. 3. Process 300 begins with step 302, in which a Web crawling process is started. A Web crawler starts at a given Web page, then follows all links to other pages that are contained in that page. The Web crawler then follows all links contained in the linked pages, an so on. Because most Web pages contain links to other pages, a Web crawler can start almost anywhere. However, in order to improve the performance of the Web crawler in finding virus sites, it is preferable to start the Web crawling process at Web pages that are likely to lead to Web pages that contain a computer virus, or information relating to a computer virus. Such likely pages to start the Web crawling process may include:

pages included in a user repository of links, such as a set of links contained by web hosting service

links entered or submitted by users, such as from a proxy,

known virus sites

links from other html pages

virus or trojan alerts, such as malware that connects to a website

links entered through VirusPatrol/Newsgroups

search engine results (“computer virus” from google.com)

Typically, Web pages and files are identified by their uniform resource locators (URL), which not only identifies each Web page and file, but also provides the capability to fetch the Web page or file over the Internet. In addition to information indicating sites that should be scanned, information indicating sites that should not be scanned may also be used. This improves efficiency by allowing sites that are known not to contain computer viruses to be skipped.

Process 300 may now continue along either or both of two paths, which may be performed individually or in parallel. In one path, process 300 continues with step 304, in which Web pages are scanned to extract links to other Web pages and files. In particular, code that defines the Web page, such as hyper-text markup language (HTML) code or extensible-markup language (XML) code, is scanned and parsed to extract links to other Web pages and files. Typically, this is done by separating the text information in the Web page, the scripts in the Web page, and the links in the Web page.

In step 306, the Web pages and files associated with the extracted links are then fetched and scanned to locate any viruses that may be contained in those Web pages and files. The fetching step is performed automatically and depends upon the type of file that is to be fetched. For example, files that include program code that would typically be run or launched by a browser program, such as Java, Active X, or object code (.exe) files, are automatically downloaded and scanned for viruses. For files that would typically be transferred using the standard file transfer protocol (FTP), the FTP sites are automatically visited and the files are downloaded and scanned for viruses. Scripts that are included in the Web pages are also automatically scanned for viruses. All scans for viruses may be performed by well-known virus scanning software.

In step 308, if the virus scan determines that a particular Web page or file contains a computer virus, then the Web page or file that contains the virus is marked as containing a virus and the Web site that hosts the Web page or file is marked as being virus hosting. In step 310, information relating to each link visited is added to a virus site database, such as that contained in virus site database 116, shown in FIG. 1. All pages that were scanned are included in the virus site database. For example, information in the database may include the URL of the Web page, the date the page was scanned, the virus that was found, if any, and status information. The status information may, for example, be used to cause revisiting of the page after a period of time or if false information is detected, or to prevent revisiting of the page. This provides the capability to monitor the progress of the Web crawler to ensure that all pending links are scanned, as well as providing the capability to periodically update scans of sites that have already been scanned.

In another path, after step 302, process 300 may continue with step 314, in which Web pages are scanned to locate virus terms in the code and text of the pages. To do this, the body of each Web page, for example, the HTML, is scanned for virus specific keywords. This is useful for scanning those Web pages that may not contain viruses, but which may, for example, include information relating to virus-making techniques. In step 316, those pages that have been found to contain virus specific terms are marked for review. Typically, this review is performed by a person who analyzes the content of the page to determine whether the site should be marked as virus hosting. In step 318, after the review has determined that the site should be marked as virus hosting, then the Web page or file that was reviewed and the Web site that hosts the Web page or file is marked as being virus hosting. In step 310, information relating to each site visited is added to a virus site database. All pages that were scanned are included in the virus site database. For example, information in the database may include the URL of the Web page, the date the page was scanned, the specific viruses that were described in the reviewed page, if any, and status information. The status information may, for example, be used to cause revisiting of the page after a period of time or if false information is detected, or to prevent revisiting of the page. This provides the capability to monitor the progress of the Web crawler to ensure that all pending links are scanned, as well as providing the capability to periodically update scans of sites that have already been scanned.

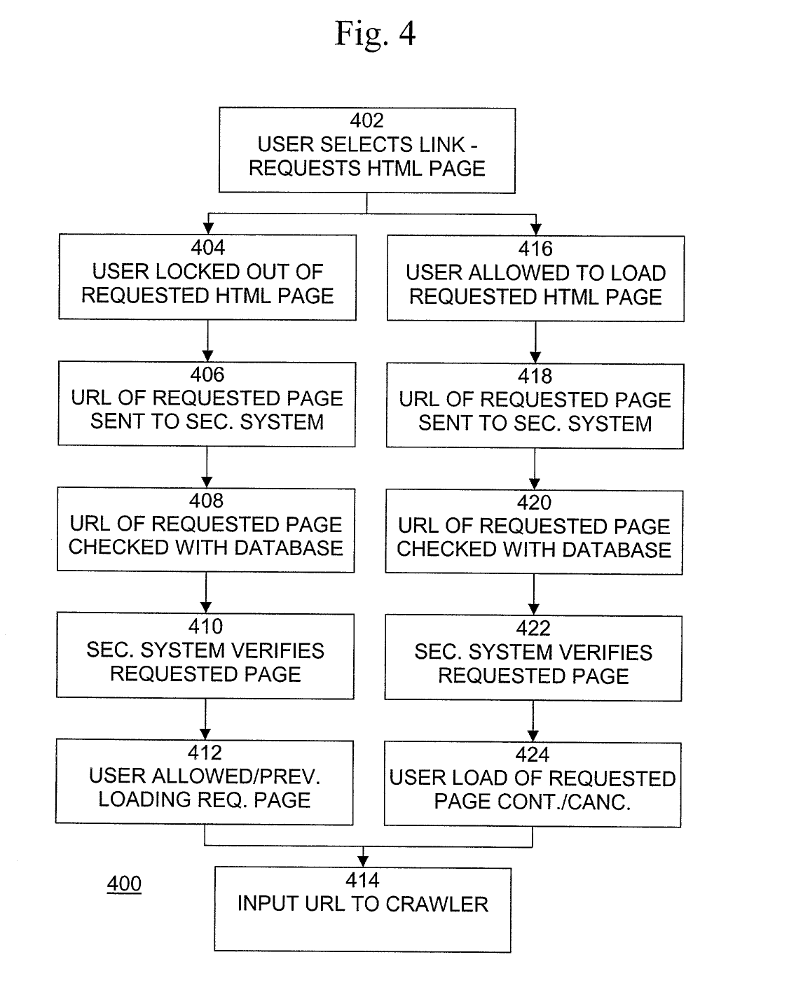

An exemplary flow diagram of a security process 400 for protecting users from virus Web sites is shown in FIG. 4. Process 400 begins with step 402, in which a user requests a Web page, such as an HTML page, by selecting a link. The link contains an URL identifying the requested page. Process 400 may now continue along either of two paths, depending upon the type of security that has been selected. In one path, process 400 continues with step 404, in which the user who requested the Web page is locked out of loading the Web page until the verification has completed. In step 406, the URL of the requested Web page is transmitted to a security system, such as Web security system 114, shown in FIG. 1. In step 408, the security system accesses the virus site database, such as virus site database 116, shown in FIG. 1, and checks the received URL against the sites marked as virus sites in the database. In step 410, the security system verifies whether the requested page is directed to a virus site. If the requested page has been verified as not directed to a virus site, then in step 412, the user is allowed to load the requested page. The lock out of the user from receiving the requested Web page, which was initiated in step 404, is removed and the user can receive the requested Web page. If the requested page is determined to be directed to a virus site, then in step 412, the user is prevented from loading the requested page. Typically, some message or notification is presented to the user indicating that the requested page will not be received. In step 414, the URL of the requested Web page is input to the Web crawler process, for example, at step 302, shown in FIG. 3.

In another path, after step 402, process 400 may continue with step 416, in which the user is allowed to load the requested Web page, while verification is occurring. In step 418, the URL of the requested Web page is transmitted to a security system, such as Web security system 114, shown in FIG. 1. In step 420, the security system accesses the virus site database, such as virus site database 116, shown in FIG. 1, and checks the received URL against the sites marked as virus sites in the database. In step 422, the security system verifies whether the requested page is directed to a virus site. If the requested Web page is determined not to be directed to a virus site, then the user load of the requested Web page is allowed to continue. If the requested page is determined to be directed to a virus site, then in step 424, the user load of the requested Web page is cancelled. Typically, some message or notification is presented to the user indicating that the requested page has been cancelled. In step 414, the URL of the requested Web page is input to the Web crawler process, for example, at step 302, shown in FIG. 3.

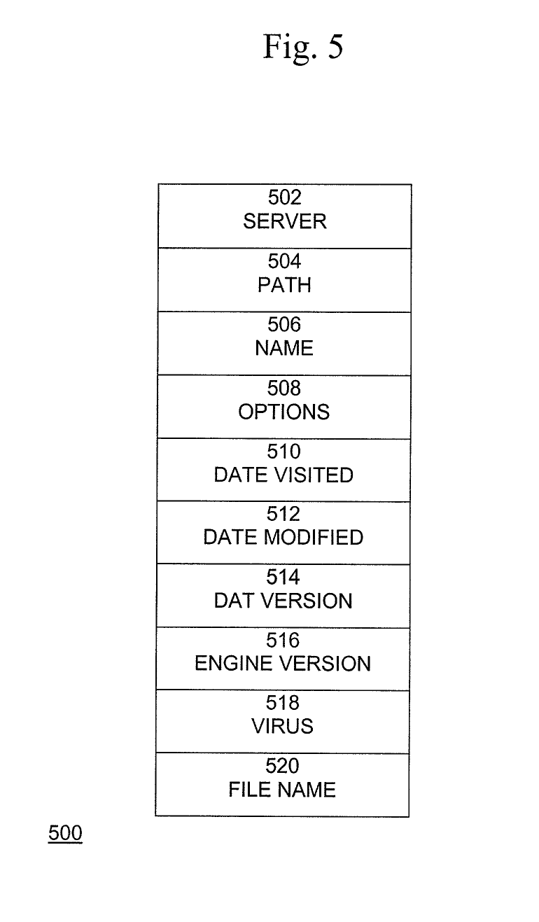

An exemplary format of a record 500 in virus site database 116, shown in FIG. 1, is shown in FIG. 5. Record 500 includes a plurality of fields, such as server field 502, path field 504, name field 506, options field 508, date visited field 510, date modified field 512, DAT version field 514, engine version field 516, virus field 518, and file name field 520. Server field 502 includes information identifying the server from which the link to the Web page or file that is the subject of the record came. Path field 504 includes the path or URL that identifies the Web page or file that is the subject of the record. Name field 506 includes information identifying the name of the Web page that is the subject of the record. Options field 508 includes options from the URL of the Web page that is the subject of the record. Date visited field 510 includes the date and/or time that the Web crawler fetched the Web page that is the subject of the record. Date modified field 512 includes the date and/or time that the Web page that is the subject of the record was last modified. This can be used to determine whether the Web page has changed since it was last scanned for viruses. DAT version field 514 includes status information relating to the Web page that is the subject of the record. Engine version field 516 includes information identifying the version of the anti-virus software that was used to scan the Web page that is the subject of the record for viruses. File name field 520 includes the file name of the Web page that is the subject of the record.

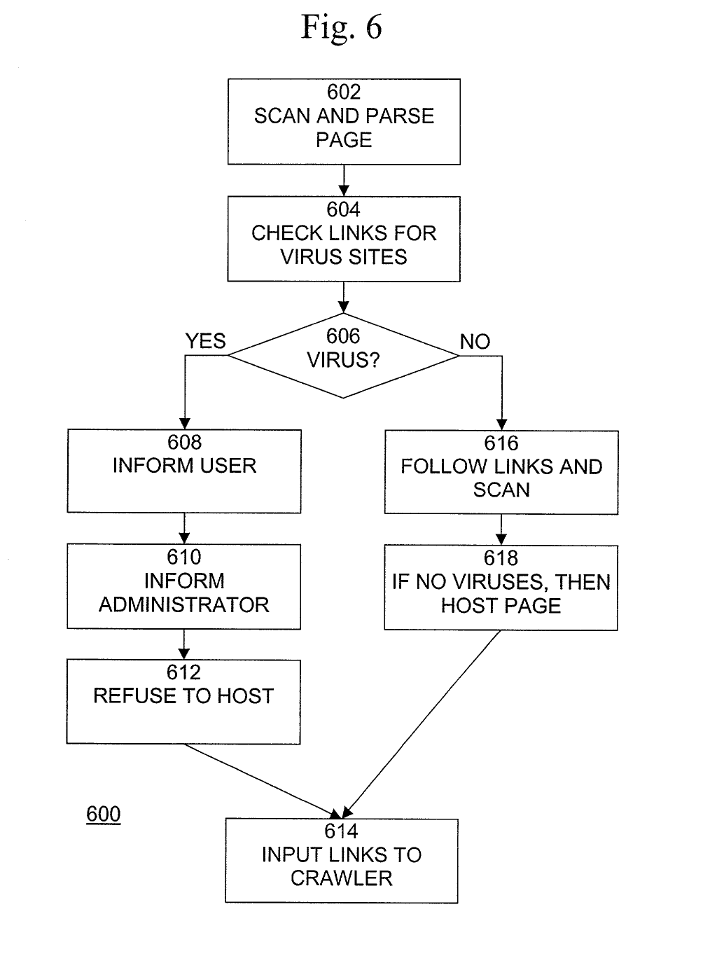

The present invention may be advantageously applied to a number of Web based operations. For example, before a Web hosting system hosts a user's Web page, that Web page may be scanned to ensure the page does not contain links to computer viruses. An exemplary flow diagram of a process 600, for protecting a Web hosting system from hosting a Web page that contains a link to a computer virus, is shown in FIG. 6. Process 600 begins with step 602, in which the Web page to be hosted is scanned to extract links to other Web pages and files. In particular, code that defines the Web page, such as hyper-text markup language (HTML) code or extensible-markup language (XML) code, is scanned and parsed to extract links to other Web pages and files. Typically, this is done by separating the text information in the Web page, the scripts in the Web page, and the links in the Web page. In step 604, the links that were identified in step 602 are checked to see if they point to known virus sites. Preferably, this step is performed by a security system, such as Web security system 114, shown in FIG. 1. In order to perform the check, the URL for each link is transmitted to the security system. The security system accesses the virus site database, such as virus site database 116, shown in FIG. 1, and checks the received URL against the sites marked as virus sites in the database. The security system then determines whether each link is directed to a virus site.

In step 606, if the security system has determined that one or more links are directed to a virus site, then process 300 continues with step 608, in which the user, who desires the Web page to be hosted, is informed that the Web page contains one or more links to a virus site. In step 610, the administrator of the Web hosting system, upon which the Web page was to be hosted, is informed that the Web page contains one or more links to a virus site. In step 612, the Web hosting system refuses to host the Web page. In step 614, the links that were visited are input to the Web crawler process, for example, at step 302, shown in FIG. 3. This provides the capability to perform a thorough scan of the links using the Web crawler process.

In step 606, if the security system has determined that no links are directed to a virus site, then process 300 continues with step 616, in which each links is followed, the pages pointed to by the links are fetched, and the fetched pages are themselves scanned for computer viruses. The links in the fetched pages may also be extracted, followed, the pages pointed to by those links fetched, and those fetched pages scanned for computer viruses. This following of nested links may proceed for as many levels as desired. In step 618, if, once the links have been followed as desired, no computer viruses have been found, then the Web hosting system will host the Web page. In step 614, the links that were visited are input to the Web crawler process, for example, at step 302, shown in FIG. 3. This provides the capability to perform a thorough scan of the links using the Web crawler process.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for protecting users from Web sites hosting computer viruses comprising the steps of:
receiving information identifying a Web page selected for access by a user;
determining whether the Web page is hosted by a Web site that is included in a database of Web sites related to computer viruses; and
allowing access to the Web page based on whether the Web page includes a link to a Web site that is included in the database.

2. The method of claim 1, further comprising the step of:
preventing access to the Web page before determining whether the Web page is included in the database.

3. The method of claim 2, wherein the allowing step comprises the steps of:
allowing access to the Web page, if the Web page is determined not to be included in the database; and
continuing to prevent access to the Web page, if the Web page is determined to be included in the database.

4. The method of claim 1, further comprising the step of:
allowing access to the Web page before determining whether the Web page is included in the database.

5. The method of claim 4, wherein the allowing step comprises the steps of:
continuing to allow access to the Web page, if the Web page is determined not to be included in the database; and
preventing access to the Web page, if the Web page is determined to be included in the database.

6. The method of claim 1, further comprising the step of:
generating the database of Web sites related to computer viruses.

7. The method of claim 6, wherein the generating step comprises the steps of:
extracting, from a first Web page, a link to a second Web page;
fetching the second Web page using the link;
scanning the second Web page for computer viruses; and
storing information relating to a Web site that is hosting the second Web page in the database.

8. The method of claim 7, wherein the stored information includes information identifying the Web site that is hosting the second Web page and information identifying any computer viruses that were found in the second Web page.

9. The method of claim 7, further comprising the steps of:
extracting, from each Web page fetched, links to other Web pages;
fetching the other Web pages using the links;
scanning the other Web pages for computer viruses; and
storing information relating to Web sites that are hosting the other Web pages in the database.

10. The method of claim 9, wherein the stored information includes information identifying the Web sites that are hosting the other Web pages and information identifying any computer viruses that were found in the other Web pages.

11. The method of claim 6, wherein the generating step comprises the steps of:
extracting, from a first Web page, a link to a second Web page;
fetching the second Web page using the link;
scanning the second Web page for terminology relating to computer viruses;
reviewing content of the second Web page to determine whether a Web site hosting the second Web page is virus hosting, if the second Web page includes terminology relating to computer viruses; and
storing information relating to the Web site that is hosting the second Web page in the database.

12. The method of claim 11, wherein the stored information includes information identifying the second Web page and information identifying any computer viruses that were found in the second Web page.

13. The method of claim 11, further comprising the steps of:
extracting, from each Web page fetched, links to other Web pages;
fetching the other Web pages using the links;
scanning the other Web pages for terminology relating to computer viruses;
reviewing content of those other Web pages that include terminology relating to computer viruses to determine whether Web sites hosting the other Web page are virus hosting; and
storing information relating to the Web sites that are hosting the other Web pages in the database.

14. The method of claim 13, wherein the stored information includes information identifying the Web sites that are hosting the other Web pages and information identifying any computer viruses that were found in the other Web pages.

15. A method for protecting a Web hosting system from hosting a Web page that contains a link to a computer virus comprising the steps of:
receiving information identifying a first Web page to be hosted by the Web hosting system;
determining whether the first Web page includes a link to a Web site that is included in a database of Web sites related to computer viruses; and
allowing hosting of the first Web page based on whether the Web page includes a link to a Web site that is included in the database.

16. The method of claim 15, wherein the determining step comprises the steps of:
extracting, from the first Web page, links to other Web pages; and
determining whether the other Web pages are hosted by Web sites that are included in the database.

17. The method of claim 16, wherein the allowing step comprises the steps of:
refusing to host the first Web page, if the first Web page includes a link to a Web page that is hosted by a Web site that is included in the database; and
hosting the first Web page, if the first Web page includes no links to a any Web pages that are hosted by a Web site that is included in the database.

18. The method of claim 17, further comprising the step of:
generating the database of Web sites related to computer viruses.

19. The method of claim 18, wherein the generating step comprises the steps of:
extracting, from a first Web page, a link to a second Web page;
fetching the second Web page using the link;
scanning the second Web page for computer viruses; and
storing information relating to a Web site that is hosting the second Web page in the database.

20. The method of claim 19, wherein the stored information includes information identifying the Web site that is hosting the second Web page and information identifying any computer viruses that were found in the second Web page.

21. The method of claim 19, further comprising the steps of:
extracting, from each Web page fetched, links to other Web pages;
fetching the other Web pages using the links;
scanning the other Web pages for computer viruses; and
storing information relating to Web sites that are hosting the other Web pages in the database.

22. The method of claim 21, wherein the stored information includes information identifying the Web sites that are hosting the other Web pages and information identifying any computer viruses that were found in the other Web pages.

23. The method of claim 18, wherein the generating step comprises the steps of:
extracting, from a first Web page, a link to a second Web page;
fetching the second Web page using the link;
scanning the second Web page for terminology relating to computer viruses;
reviewing content of the second Web page to determine whether a Web site hosting the second Web page is virus hosting, if the second Web page includes terminology relating to computer viruses; and
storing information relating to the Web site that is hosting the second Web page in the database.

24. The method of claim 23, wherein the stored information includes information identifying the second Web page and information identifying any computer viruses that were found in the second Web page.

25. The method of claim 23, further comprising the steps of:
extracting, from each Web page fetched, links to other Web pages;
fetching the other Web pages using the links;
scanning the other Web pages for terminology relating to computer viruses;
reviewing content of those other Web pages that include terminology relating to computer viruses to determine whether Web sites hosting the other Web page are virus hosting; and
storing information relating to the Web sites that are hosting the other Web pages in the database.

26. The method of claim 25, wherein the stored information includes information identifying the Web sites that are hosting the other Web pages and information identifying any computer viruses that were found in the other Web pages.

27. A system for protecting users from Web sites hosting computer viruses comprising:
a processor operable to execute computer program instructions;
a memory operable to store computer program instructions executable by the processor; and
computer program instructions stored in the memory and executable to perform the steps of:
receiving information identifying a Web page selected for access by a user;
determining whether the Web page is hosted by a Web site that is included in a database of Web sites related to computer viruses; and
allowing access to the Web page based on whether the Web page includes a link to a Web site that is included in the database.

28. The system of claim 27, further comprising computer program instructions executable to perform the step of:
preventing access to the Web page before determining whether the Web page is included in the database.

29. The system of claim 28, wherein the allowing step comprises the steps of:
allowing access to the Web page, if the Web page is determined not to be included in the database; and
continuing to prevent access to the Web page, if the Web page is determined to be included in the database.

30. The system of claim 27, further comprising computer program instructions executable to perform the step of:
allowing access to the Web page before determining whether the Web page is included in the database.

31. The system of claim 30, wherein the allowing step comprises the steps of:
continuing to allow access to the Web page, if the Web page is determined not to be included in the database; and
preventing access to the Web page, if the Web page is determined to be included in the database.

32. The system of claim 27, further comprising computer program instructions executable to perform the step of:
generating the database of Web sites related to computer viruses.

33. The system of claim 32, wherein the generating step comprises the steps of:
extracting, from a first Web page, a link to a second Web page;
fetching the second Web page using the link;
scanning the second Web page for computer viruses; and
storing information relating to a Web site that is hosting the second Web page in the database.

34. The system of claim 33, wherein the stored information includes information identifying the Web site that is hosting the second Web page and information identifying any computer viruses that were found in the second Web page.

35. The system of claim 33, further comprising computer program instructions executable to perform the steps of:
extracting, from each Web page fetched, links to other Web pages;
fetching the other Web pages using the links;
scanning the other Web pages for computer viruses; and
storing information relating to Web sites that are hosting the other Web pages in the database.

36. The system of claim 35, wherein the stored information includes information identifying the Web sites that are hosting the other Web pages and information identifying any computer viruses that were found in the other Web pages.

37. The system of claim 32, wherein the generating step comprises the steps of:
extracting, from a first Web page, a link to a second Web page;
fetching the second Web page using the link;
scanning the second Web page for terminology relating to computer viruses;
reviewing content of the second Web page to determine whether a Web site hosting the second Web page is virus hosting, if the second Web page includes terminology relating to computer viruses; and
storing information relating to the Web site that is hosting the second Web page in the database.

38. The system of claim 37, wherein the stored information includes information identifying the second Web page and information identifying any computer viruses that were found in the second Web page.

39. The system of claim 37, further comprising computer program instructions executable to perform the steps of:
extracting, from each Web page fetched, links to other Web pages;
fetching the other Web pages using the links;
scanning the other Web pages for terminology relating to computer viruses;
reviewing content of those other Web pages that include terminology relating to computer viruses to determine whether Web sites hosting the other Web page are virus hosting; and
storing information relating to the Web sites that are hosting the other Web pages in the database.

40. The system of claim 39, wherein the stored information includes information identifying the Web sites that are hosting the other Web pages and information identifying any computer viruses that were found in the other Web pages.

41. A system for protecting a Web hosting system from hosting a Web page that contains a link to a computer virus comprising:
a processor operable to execute computer program instructions;
a memory operable to store computer program instructions executable by the processor; and
computer program instructions stored in the memory and executable to perform the steps of:
receiving information identifying a first Web page to be hosted by the Web hosting system;
determining whether the first Web page includes a link to a Web site that is included in a database of Web sites related to computer viruses; and
allowing hosting of the first Web page based on whether the Web page includes a link to a Web site that is included in the database.

42. The system of claim 41, wherein the determining step comprises the steps of:
extracting, from the first Web page, links to other Web pages; and
determining whether the other Web pages are hosted by Web sites that are included in the database.

43. The system of claim 42, wherein the allowing step comprises the steps of:
refusing to host the first Web page, if the first Web page includes a link to a Web page that is hosted by a Web site that is included in the database; and
hosting the first Web page, if the first Web page includes no links to a any Web pages that are hosted by a Web site that is included in the database.

44. The system of claim 43, further comprising computer program instructions executable to perform the steps of:
generating the database of Web sites related to computer viruses.

45. The system of claim 44, wherein the generating step comprises the steps of:
extracting, from a first Web page, a link to a second Web page;
fetching the second Web page using the link;
scanning the second Web page for computer viruses; and
storing information relating to a Web site that is hosting the second Web page in the database.

46. The system of claim 45, wherein the stored information includes information identifying the Web site that is hosting the second Web page and information identifying any computer viruses that were found in the second Web page.

47. The system of claim 45, further comprising computer program instructions executable to perform the steps of:
extracting, from each Web page fetched, links to other Web pages;
fetching the other Web pages using the links;
scanning the other Web pages for computer viruses; and
storing information relating to Web sites that are hosting the other Web pages in the database.

48. The system of claim 47, wherein the stored information includes information identifying the Web sites that are hosting the other Web pages and information identifying any computer viruses that were found in the other Web pages.

49. The system of claim 44, wherein the generating step comprises the steps of:
extracting, from a first Web page, a link to a second Web page;
fetching the second Web page using the link;
scanning the second Web page for terminology relating to computer viruses;
reviewing content of the second Web page to determine whether a Web site hosting the second Web page is virus hosting, if the second Web page includes terminology relating to computer viruses; and
storing information relating to the Web site that is hosting the second Web page in the database.

50. The system of claim 49, wherein the stored information includes information identifying the second Web page and information identifying any computer viruses that were found in the second Web page.

51. The system of claim 49, further comprising computer program instructions executable to perform the steps of:
extracting, from each Web page fetched, links to other Web pages;
fetching the other Web pages using the links;
scanning the other Web pages for terminology relating to computer viruses;
reviewing content of those other Web pages that include terminology relating to computer viruses to determine whether Web sites hosting the other Web page are virus hosting; and
storing information relating to the Web sites that are hosting the other Web pages in the database.

52. The system of claim 51, wherein the stored information includes information identifying the Web sites that are hosting the other Web pages and information identifying any computer viruses that were found in the other Web pages.

53. A computer program product for protecting users from Web sites hosting computer viruses, comprising:
a computer readable medium;
computer program instructions, recorded on the computer readable medium, executable by a processor, for performing the steps of
receiving information identifying a Web page selected for access by a user;
determining whether the Web page is hosted by a Web site that is included in a database of Web sites related to computer viruses; and
allowing access to the Web page based on whether the Web page includes a link to a Web site that is included in the database.

54. The computer program product of claim 53, further comprising computer program instructions executable to perform the steps of:
preventing access to the Web page before determining whether the Web page is included in the database.

55. The computer program product of claim 54, wherein the allowing step comprises the steps of:
allowing access to the Web page, if the Web page is determined not to be included in the database; and
continuing to prevent access to the Web page, if the Web page is determined to be included in the database.

56. The computer program product of claim 53, further comprising computer program instructions executable to perform the steps of:
allowing access to the Web page before determining whether the Web page is included in the database.

57. The computer program product of claim 56, wherein the allowing step comprises the steps of:
continuing to allow access to the Web page, if the Web page is determined not to be included in the database; and
preventing access to the Web page, if the Web page is determined to be included in the database.

58. The computer program product of claim 53, further comprising computer program instructions executable to perform the steps of:
generating the database of Web sites related to computer viruses.

59. The computer program product of claim 58, wherein the generating step comprises the steps of:
extracting, from a first Web page, a link to a second Web page;
fetching the second Web page using the link;
scanning the second Web page for computer viruses; and
storing information relating to a Web site that is hosting the second Web page in the database.

60. The computer program product of claim 59, wherein the stored information includes information identifying the Web site that is hosting the second Web page and information identifying any computer viruses that were found in the second Web page.

61. The computer program product of claim 59, further comprising computer program instructions executable to perform the steps of:
extracting, from each Web page fetched, links to other Web pages;
fetching the other Web pages using the links;
scanning the other Web pages for computer viruses; and
storing information relating to Web sites that are hosting the other Web pages in the database.

62. The computer program product of claim 61, wherein the stored information includes information identifying the Web sites that are hosting the other Web pages and information identifying any computer viruses that were found in the other Web pages.

63. The computer program product of claim 58, wherein the generating step comprises the steps of:
extracting, from a first Web page, a link to a second Web page;
fetching the second Web page using the link;
scanning the second Web page for terminology relating to computer viruses;
reviewing content of the second Web page to determine whether a Web site hosting the second Web page is virus hosting, if the second Web page includes terminology relating to computer viruses; and
storing information relating to the Web site that is hosting the second Web page in the database.

64. The computer program product of claim 63, wherein the stored information includes information identifying the second Web page and information identifying any computer viruses that were found in the second Web page.

65. The computer program product of claim 63, further comprising computer program instructions executable to perform the steps of:
extracting, from each Web page fetched, links to other Web pages;
fetching the other Web pages using the links;
scanning the other Web pages for terminology relating to computer viruses;
reviewing content of those other Web pages that include terminology relating to computer viruses to determine whether Web sites hosting the other Web page are virus hosting; and
storing information relating to the Web sites that are hosting the other Web pages in the database.

66. The computer program product of claim 65, wherein the stored information includes information identifying the Web sites that are hosting the other Web pages and information identifying any computer viruses that were found in the other Web pages.

67. A computer program product for protecting a Web hosting system from hosting a Web page that contains a link to a computer virus, comprising:
a computer readable medium;
computer program instructions, recorded on the computer readable medium, executable by a processor, for performing the steps of
receiving information identifying a first Web page to be hosted by the Web hosting system;
determining whether the first Web page includes a link to a Web site that is included in a database of Web sites related to computer viruses; and
allowing hosting of the first Web page based on whether the Web page includes a link to a Web site that is included in the database.

68. The computer program product of claim 67, wherein the determining step comprises the steps of:
extracting, from the first Web page, links to other Web pages; and
determining whether the other Web pages are hosted by Web sites that are included in the database.

69. The computer program product of claim 68, wherein the allowing step comprises the steps of:
refusing to host the first Web page, if the first Web page includes a link to a Web page that is hosted by a Web site that is included in the database; and
hosting the first Web page, if the first Web page includes no links to a any Web pages that are hosted by a Web site that is included in the database.

70. The computer program product of claim 69, further comprising computer program instructions executable to perform the steps of:
generating the database of Web sites related to computer viruses.

71. The computer program product of claim 70, wherein the generating step comprises the steps of:
extracting, from a first Web page, a link to a second Web page;
fetching the second Web page using the link;
scanning the second Web page for computer viruses; and
storing information relating to a Web site that is hosting the second Web page in the database.

72. The computer program product of claim 71, wherein the stored information includes information identifying the Web site that is hosting the second Web page and information identifying any computer viruses that were found in the second Web page.

73. The computer program product of claim 71, further comprising computer program instructions executable to perform the steps of:
extracting, from each Web page fetched, links to other Web pages;
fetching the other Web pages using the links;
scanning the other Web pages for computer viruses; and
storing information relating to Web sites that are hosting the other Web pages in the database.

74. The computer program product of claim 73, wherein the stored information includes information identifying the Web sites that are hosting the other Web pages and information identifying any computer viruses that were found in the other Web pages.

75. The computer program product of claim 70, wherein the generating step comprises the steps of:
extracting, from a first Web page, a link to a second Web page;
fetching the second Web page using the link;
scanning the second Web page for terminology relating to computer viruses;
reviewing content of the second Web page to determine whether a Web site hosting the second Web page is virus hosting, if the second Web page includes terminology relating to computer viruses; and
storing information relating to the Web site that is hosting the second Web page in the database.

76. The computer program product of claim 75, wherein the stored information includes information identifying the second Web page and information identifying any computer viruses that were found in the second Web page.

77. The computer program product of claim 75, further comprising computer program instructions executable to perform the steps of:
extracting, from each Web page fetched, links to other Web pages;
fetching the other Web pages using the links;
scanning the other Web pages for terminology relating to computer viruses;
reviewing content of those other Web pages that include terminology relating to computer viruses to determine whether Web sites hosting the other Web page are virus hosting; and
storing information relating to the Web sites that are hosting the other Web pages in the database.

78. The computer program product of claim 77, wherein the stored information includes information identifying the Web sites that are hosting the other Web pages and information identifying any computer viruses that were found in the other Web pages.
